(19) United States
(12) Patent Application Publication
(10) Pub. No.: US 2023/0024470 A1
(43) Pub. Date: Jan. 26, 2023

(54) IDENTIFICATION OF INNER FIBERS OF DEPLOYED FIBER CABLES USING DISTRIBUTED FIBER OPTIC SENSING

(71) Applicant: NEC Laboratories America, Inc., Princeton, NJ (US)

(72) Inventors: Ming-Fang HUANG, Princeton, NJ (US); Ting WANG, West Windsor, NY (US)

(73) Assignee: NEC LABORATORIES AMERICA, INC, Princeton, NJ (US)

(21) Appl. No.: 17/871,888

(22) Filed: Jul. 22, 2022

Related U.S. Application Data
(60) Provisional application No. 63/224,963, filed on Jul. 23, 2021.

(51) Int. Cl. G01D 5/353; G01H 9/00

(52) U.S. Cl. CPC G01D 5/35361; G01H 9/004

(57) ABSTRACT

Systems, and methods for automatically identifying individual fibers within an optical fiber cable that are experiencing some form of significant signal impairment such as a fiber cut. Operationally, distributed fiber optic sensing (DFOS) systems are used to detect reflected signals along the length of the affected fiber(s) and a determination of affected fiber(s) is made from changes in reflection characteristics.

### CROSS REFERENCE TO RELATED APPLICATIONS

This application claims the benefit of U.S. Provisional Patent Application Ser. No. 63/224,963 filed 23 Jul. 2021 the entire contents of which is incorporated by reference as if set forth at length herein.

### TECHNICAL FIELD

This disclosure relates generally to optical fiber telecommunications facilities and distributed fiber optic sensing (DFOS) over same. More particularly, it describes systems and methods for the identification of inner fibers of deployed fiber cables using distributed fiber optic sensing.

### BACKGROUND

As is known, there are presently many millions of miles of deployed optical fiber telecommunications facilities providing numerous contemporary telecommunications services. Such deployed facilities include optical fiber cables which—in order to enhance efficient deployment—include large numbers of individual fibers. Consequently, it is of critical importance for telecommunications service providers to locate a individual fiber within a large optical fiber cable when the fiber cable experiences a fault (e.g., fiber cut or other damage). Oftentimes, service providers must rely on manual recorded information and/or construction/site maps—which are oftentimes out of date. Accordingly, systems and methods that facilitate the localization of individual fibers within a fiber optic cable would represent a welcome addition to the art.

### SUMMARY

An advance in the art is made according to aspects of the present disclosure directed to systems and methods for automatically determining individual fibers within an optical fiber cable that are experiencing some form of significant signal impairment. Operationally, our inventive systems and methods utilize reflection changes from an end of an optical fiber cut point. DFOS systems are used to detect the reflected signals along the fiber(s). When the optical fiber is cut, reflected signals are larger than in uncut fiber(s) due to the ˜4% reflection from air.

More particularly, our inventive method according to aspects of the present disclosure provides a DFOS system and connects that system to a field fiber in a survey; a technician is deployed to a location at which the cable (fiber) cut is noted; the technical terminates a fiber or applies an index matching gel to an end to change index; the technician repeatedly changes the fiber terminated or having applied thereto the index matching gel while DFOS is operational; DFOS identifies reduced reflected signals and identifies affected fiber; technician fixes the damaged fiber.

### BRIEF DESCRIPTION OF THE DRAWING

A more complete understanding of the present disclosure may be realized by reference to the accompanying drawing in which:

FIG. 1 is a schematic diagram of an illustrative distributed fiber optic sensing system according to aspects of the present disclosure;

FIG. 2(A) and FIG. 2(B) are schematic diagrams illustrating issues of cable cuts in a deployed fiber optic cable according to aspects of the present disclosure;

FIG. 3 is a schematic diagram showing an illustrative architectural layout according to aspects of the present disclosure;

FIG. 4 is a schematic diagram showing an illustrative experimental setup according to aspects of the present disclosure;

FIG. 5 is a plot showing an illustrative signal received by DAS when fiber is spliced to a FC/APC fiber patch cable according to aspects of the present disclosure;

FIG. 6 is a plot showing an illustrative signal received by DAS when fiber is broken by hand according to aspects of the present disclosure;

FIG. 7 is a plot showing an illustrative signal received by DAS when fiber end is located inside water according to aspects of the present disclosure;

FIG. 8 is a plot showing an illustrative signal received by DAS when fiber is broken by hand according to aspects of the present disclosure;

FIG. 9 is a plot showing an illustrative signal received by DAS when fiber end is located inside water according to aspects of the present disclosure;

FIG. 10 is a plot showing an illustrative signal received by DAS when fiber end is terminated according to aspects of the present disclosure;

FIG. 11 is a schematic feature diagram showing illustrative features of methods according to aspects of the present disclosure; and

FIG. 12 is a flow diagram showing an illustrative method according to aspects of the present disclosure.

The illustrative embodiments are described more fully by the Figures and detailed description. Embodiments according to this disclosure may, however, be embodied in various forms and are not limited to specific or illustrative embodiments described in the drawing and detailed description.

### DESCRIPTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are intended to be only for pedagogical purposes to aid the reader in understanding the principles of the disclosure and the concepts contributed by the inventor(s) to furthering the art and are to be construed as being without limitation to such specifically recited examples and conditions.

Moreover, all statements herein reciting principles, aspects, and embodiments of the disclosure, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

Thus, for example, it will be appreciated by those skilled in the art that any block diagrams herein represent conceptual views of illustrative circuitry embodying the principles of the disclosure.

Unless otherwise explicitly specified herein, the FIGs comprising the drawing are not drawn to scale.

By way of some additional background, we note that distributed fiber optic sensing systems interconnect opto-electronic integrators to an optical fiber (or cable), converting the fiber to an array of sensors distributed along the length of the fiber. In effect, the fiber becomes a sensor, while the interrogator generates/injects laser light energy into the fiber and senses/detects events along the fiber length.

As those skilled in the art will understand and appreciate, DFOS technology can be deployed to continuously monitor vehicle movement, human traffic, excavating activity, seismic activity, temperatures, structural integrity, liquid and gas leaks, and many other conditions and activities. It is used around the world to monitor power stations, telecom networks, railways, roads, bridges, international borders, critical infrastructure, terrestrial and subsea power and pipelines, and downhole applications in oil, gas, and enhanced geothermal electricity generation. Advantageously, distributed fiber optic sensing is not constrained by line of sight or remote power access and—depending on system configuration—can be deployed in continuous lengths exceeding 30 miles with sensing/detection at every point along its length. As such, cost per sensing point over great distances typically cannot be matched by competing technologies.

Fiber optic sensing measures changes in “backscattering” of light occurring in an optical sensing fiber when the sensing fiber encounters vibration, strain, or temperature change events. As noted, the sensing fiber serves as sensor over its entire length, delivering real time information on physical/environmental surroundings, and fiber integrity/security. Furthermore, distributed fiber optic sensing data pinpoints a precise location of events and conditions occurring at or near the sensing fiber.

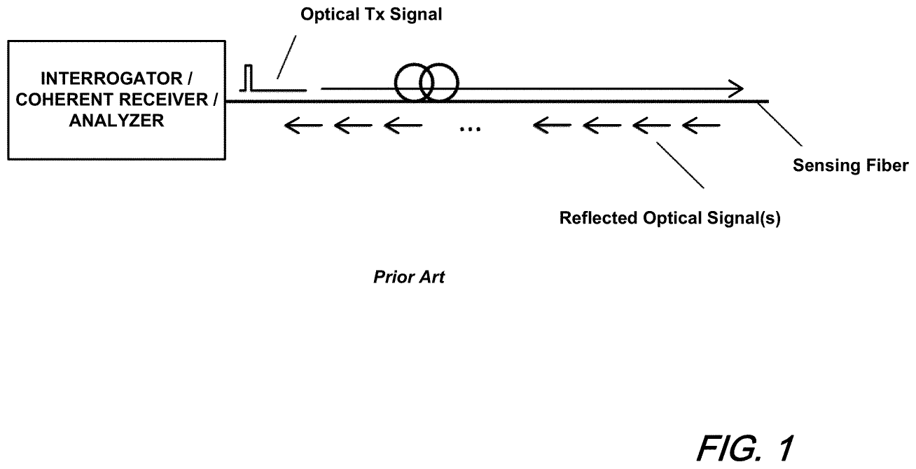

A schematic diagram illustrating the generalized arrangement and operation of a distributed fiber optic sensing system including artificial intelligence analysis and cloud storage/service is shown in FIG. 1. With reference to FIG. 1 one may observe an optical sensing fiber that in turn is connected to an interrogator. As is known, contemporary interrogators are systems that generate an input signal to the fiber and detects/analyzes reflected/scattered and subsequently received signal(s). The signals are analyzed, and an output is generated which is indicative of the environmental conditions encountered along the length of the fiber. The signal(s) so received may result from reflections in the fiber, such as Raman backscattering, Rayleigh backscattering, and Brillion backscattering. It can also be a signal of forward direction that uses the speed difference of multiple modes. Without losing generality, the following description assumes reflected signal though the same approaches can be applied to forwarded signal as well.

As will be appreciated, a contemporary DFOS system includes the interrogator that periodically generates optical pulses (or any coded signal) and injects them into an optical fiber. The injected optical pulse signal is conveyed along the optical fiber.

At locations along the length of the fiber, a small portion of signal is scattered/reflected and conveyed back to the interrogator. The scattered/reflected signal carries information the interrogator uses to detect, such as a power level change that indicates—for example—a mechanical vibration.

The reflected signal is converted to electrical domain and processed inside the interrogator. Based on the pulse injection time and the time signal is detected, the interrogator determines at which location along the fiber the signal is coming from, thus able to sense the activity of each location along the fiber.

Distributed Acoustic Sensing (DAS)/Distributed Vibrational Sensing (DVS) systems detect vibrations and capture acoustic energy along the length of optical sensing fiber. Advantageously, existing, traffic carrying fiber optic networks may be utilized and turned into a distributed acoustic sensor, capturing real-time data. Classification algorithms may be further used to detect and locate events such as leaks, cable faults, intrusion activities, or other abnormal events including both acoustic and/or vibrational.

Various DAS/DVS technologies are presently used with the most common being based on Coherent Optical Time Domain Reflectometry (C-OTDR). C-OTDR utilizes Rayleigh back-scattering, allowing acoustic frequency signals to be detected over long distances. An interrogator sends a coherent laser pulse along the length of an optical sensor fiber (cable). Scattering sites within the fiber cause the fiber to act as a distributed interferometer with a gauge length like that of the pulse length (e.g. 10 meters). Acoustic/mechanical disturbance acting on the sensor fiber generates microscopic elongation or compression of the fiber (micro-strain), which causes a change in the phase relation and/or amplitude of the light pulses traversing therein.

Before a next laser pulse is be transmitted, a previous pulse must have had time to travel the full length of the sensing fiber and for its scattering/reflections to return. Hence the maximum pulse rate is determined by the length of the fiber. Therefore, acoustic signals can be measured that vary at frequencies up to the Nyquist frequency, which is typically half of the pulse rate. As higher frequencies are attenuated very quickly, most of the relevant ones to detect and classify events are in the lower of the 2 kHz range.

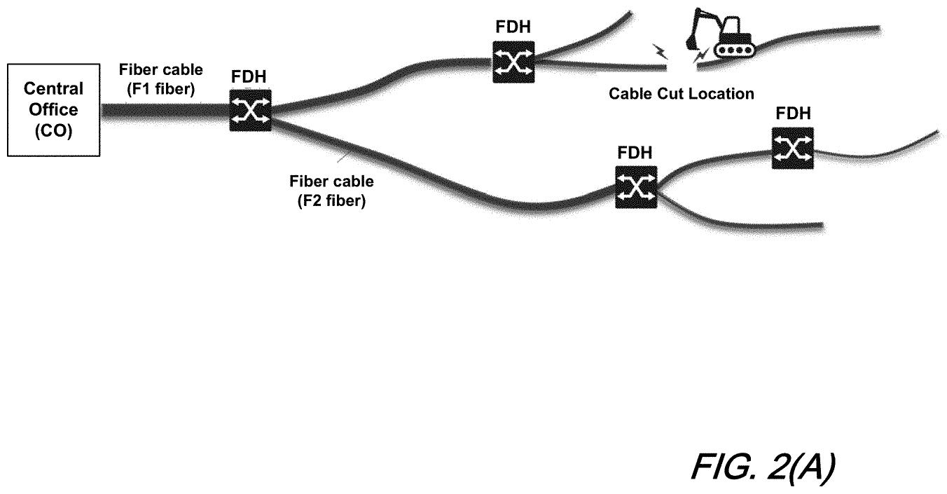

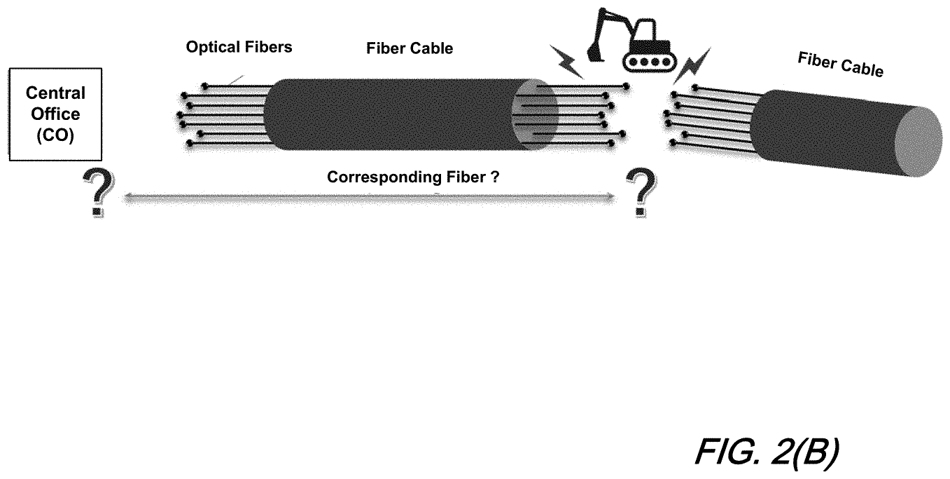

FIG. 2(A) and FIG. 2(B) are schematic diagrams illustrating issues of cable cuts in a deployed fiber optic cable according to aspects of the present disclosure. Typically, as illustrated in FIG. 2(A), the deployed fiber cables include F1 fiber (the major fiber cable from the central office) and F2 fiber (drop fiber from a fiber distributed hub (FDH). Note that there are oftentimes hundreds/thousands of individual optical fibers inside an F1 fiber cable and tens/hundreds of individual optical fibers inside an F2 fiber cable that is oftentimes buried underground. Once a cable cut event occurs, it is difficult to locate the affected fiber that requires immediate repair as illustratively shown in FIG. 2(B). Of course, deployed field technicians can repair entire bundles of fibers of a cut cable, but it is a time-consuming project. As a result, the deployed field technicians will generally identify/fix a fiber with respect to an order of customer urgency.

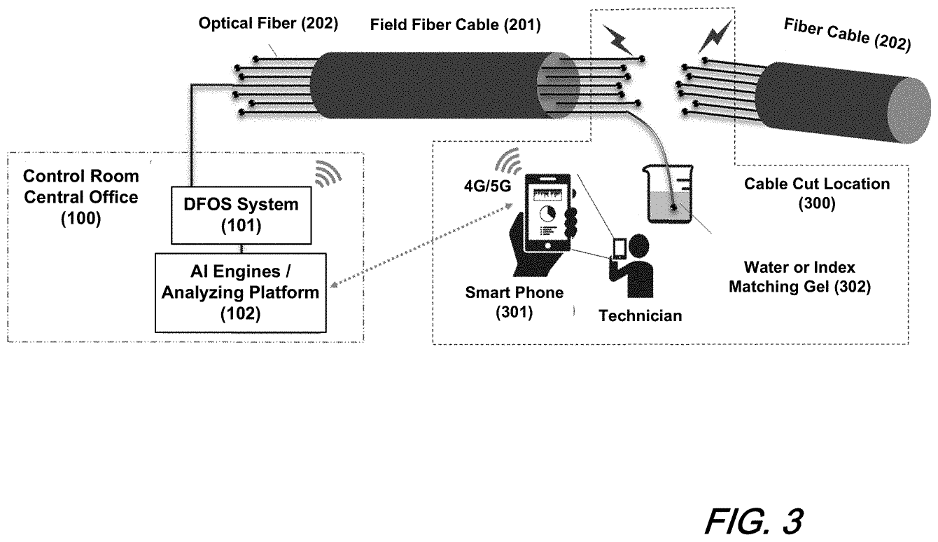

FIG. 3 is a schematic diagram showing an illustrative architectural layout according to aspects of the present disclosure. With reference to that figure it may be observed that a distributed fiber optic sensing system (DFOS) (101) can advantageously be distributed acoustic sensing (DAS) and/or distributed vibration sensing (DVS) system and is generally located in a control office (CO)/central office (100) for remote monitoring of an entire cable route. The DFOS system is connected to the field optical fiber to provide sensing functions. Advantageously, the sensor fiber can be a dark fiber (not carrying live traffic) or an operational fiber (carrying live traffic) from service providers. Once the cable cut event happened the following operations are performed:

Step-1: Connected the fiber to DFOS systems. Field technicians connect a dark fiber or targeted fiber (the fiber needs to repair ASAP due to customer's urgent needs) (202) inside the fiber cable (201) to the DFOS system.

Step-2: Go to the field with mobile devices. The field technicians relocate to the cable cut location (300) with a mobile device (301) which communicates with and receives real-time signal analyzing results from the DFOS systems (101/102) by 4G/5G signals.

Step-3: Put fiber into a cup of water or index matching gel to identify the targeted fiber. Preparing a water bath or index matching gel (IMG), insert the fiber (any fiber) into the water or IMG, and wait for the sensing results from the mobile device. If the testing fiber is not the targeted one (connected to the DFOS system), change to another fiber till identify the targeted fiber.

Step-4: Repair the fiber. After identifying the targeted fiber, technicians repair the fiber to reduce the service down time.

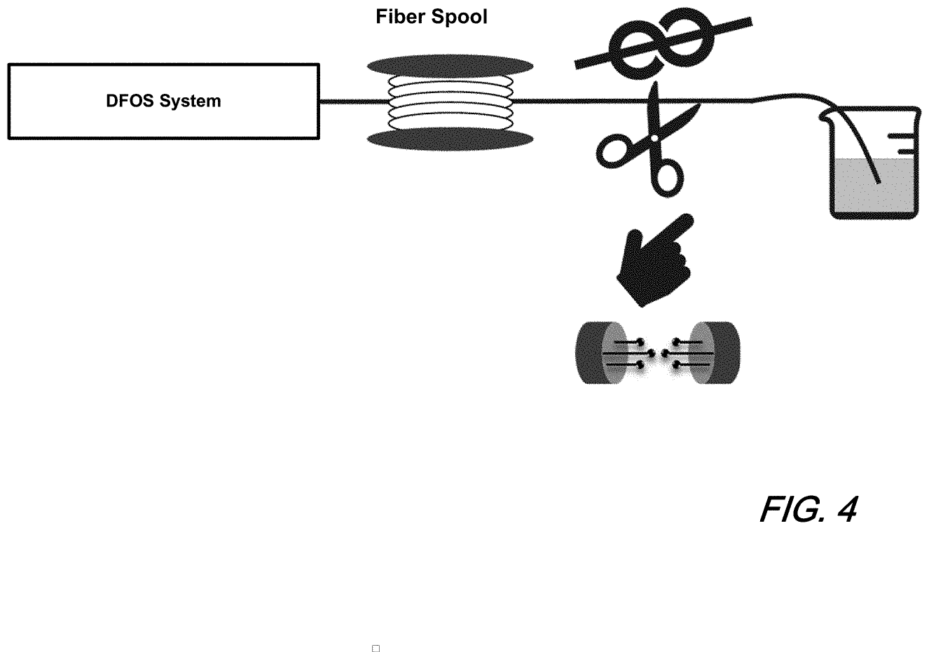

FIG. 4 is a schematic diagram showing an illustrative experimental setup according to aspects of the present disclosure.

To evaluate our inventive method, lab experiments have been performed to emulate fiber cut events. The experimental setup is shown in FIG. 4. One end of a 19.95-km fiber spool was connected to a DFOS system, and the other end was put inside a water bath. Few events were simulated: (1) spliced the fiber to an APC fiber patch cable, (2) fiber broken by hand, (3) fiber broken by a scissor, and (4) terminated fiber.

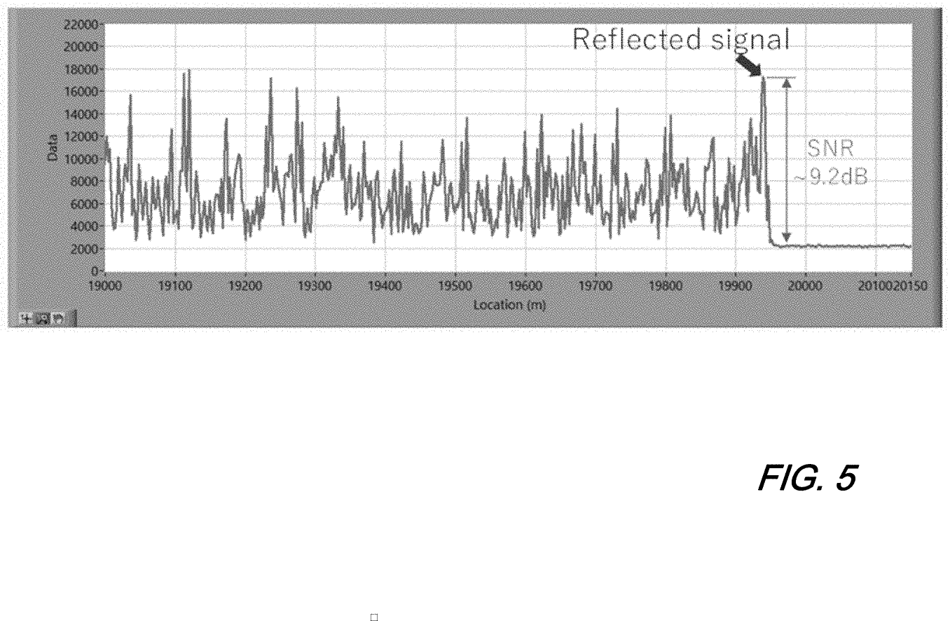

FIG. 5 is a plot showing an illustrative signal received by DAS when fiber is spliced to a FC/APC fiber patch cable according to aspects of the present disclosure.

Event-1: Spliced the fiber to an APC fiber patch cable. FIG. 5 shows a plot of received reflected signals by DAS when the fiber was spliced to a FC/APC fiber patch cable. The last reflected signal represented the end point of the APC jumper. It can be observed from this plot that the reflected signal is higher than the neighboring signals with SNR of ˜9.2 dB caused by the air inside the fiber cap.

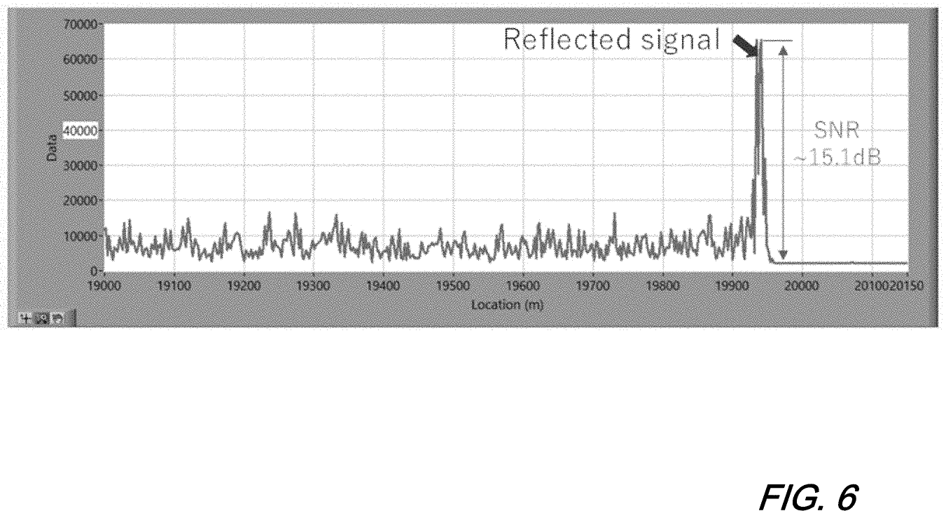

FIG. 6 is a plot showing an illustrative signal received by DAS when fiber is broken by hand according to aspects of the present disclosure.

Event-2: Fiber broken by hand. FIG. 6 shows the received reflected signals by DAS when the fiber was broken by hand (simulated cable cut event). It can be observed from this figure that the reflected signal is much higher than the neighboring signals with SNR of >15 dB caused by the reflection in air.

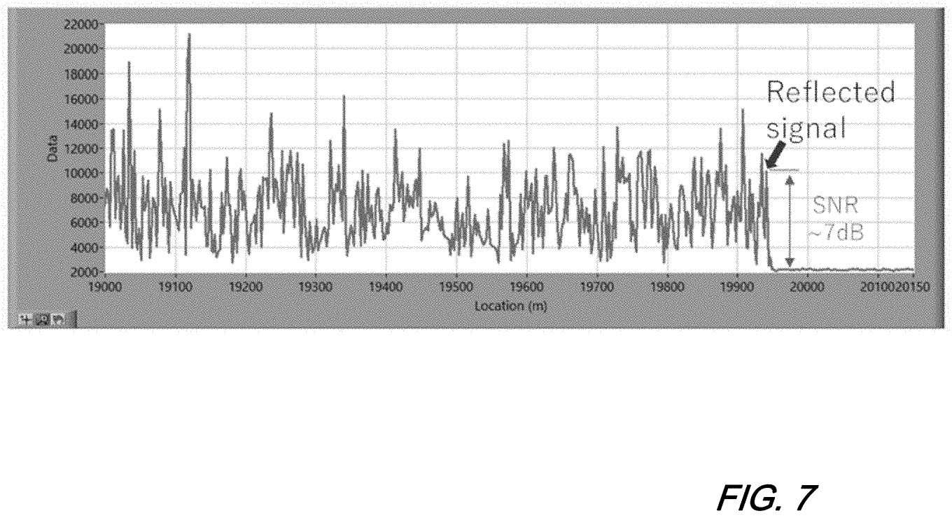

FIG. 7 is a plot showing an illustrative signal received by DAS when fiber end is located inside water according to aspects of the present disclosure. It may be observed from this figure that the reflected signals are significantly reduced to ˜7 dB which is similar to the neighboring signals due to the index change and reduce the reflected signal traveling back to the DAS.

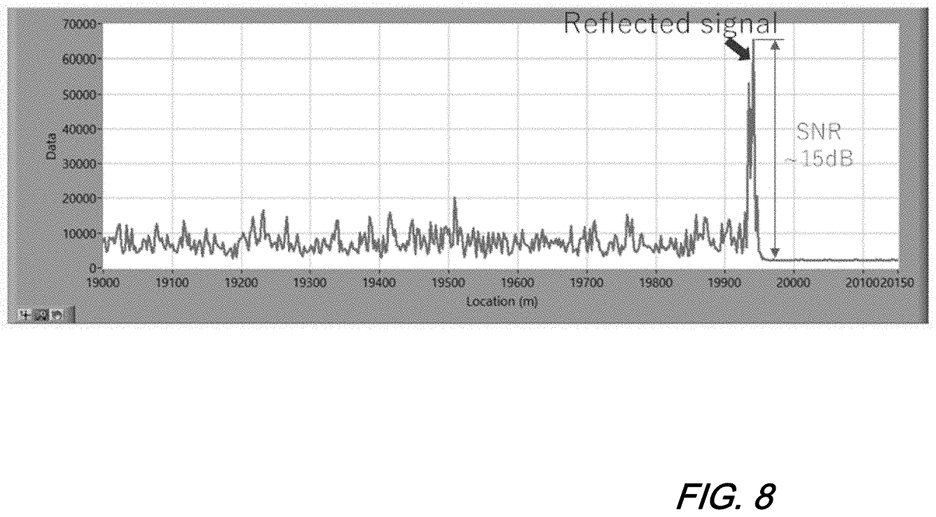

FIG. 8 is a plot showing an illustrative signal received by DAS when fiber is broken by hand according to aspects of the present disclosure.

Event-3: Fiber broke by a scissor. FIG. 8 shows the received reflected signals by DAS when the fiber was broken by a scissor to simulate a cable cut event. It can be observed from this figure that the reflected signal is much higher than the neighboring signals with SNR of >15 dB caused by the reflection in air.

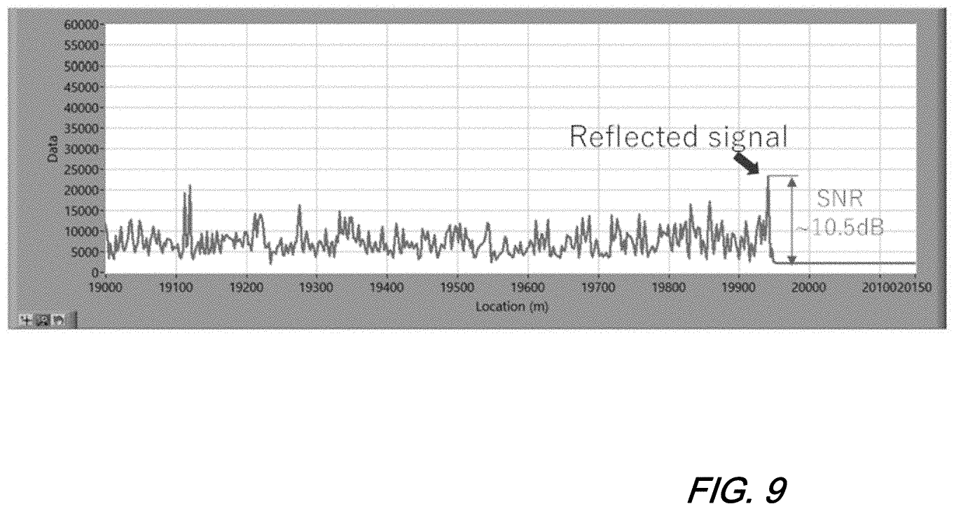

FIG. 9 is a plot showing an illustrative signal received by DAS when fiber end is located inside water according to aspects of the present disclosure. FIG. 9 shows the received reflected signals when the cut fiber was located under water. It may be observed from this figure that the reflected signals significantly reduced to ˜10.5 dB. This reflected signal was higher than the one broken by hand, which may result from the flat cutting surface produced by a scissor as compared to the non-flat surface produced by hand cutting. Even though, the signal SNR was reduced from air to water due to the index change

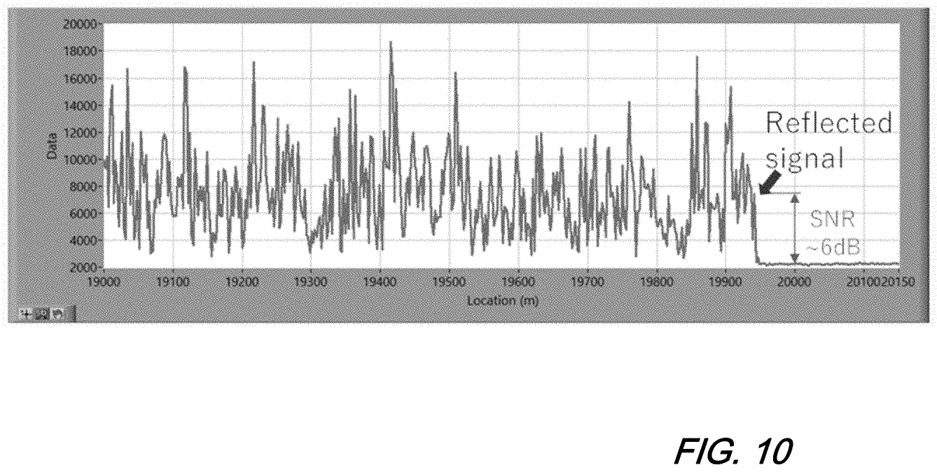

FIG. 10 is a plot showing an illustrative signal received by DAS when fiber end is terminated according to aspects of the present disclosure.

Event-4: Fiber termination. FIG. 10 shows the received reflected signals by DAS when the fiber was terminated. The SNR is similar or lower than the neighboring signals, which indicates that there are no additional reflections from the end point. Based on the experimental results, the our disclosed inner fiber identification method effectively determines individual fibers based on the intensity changes of reflected signals. As we have shown, fiber termination techniques when used with our DFOS methodology works best. Advantageously, if such termination is impossible or otherwise impractical in a particular field operation, a technician can insert the fiber into water or index matching gel to change the reflective index.

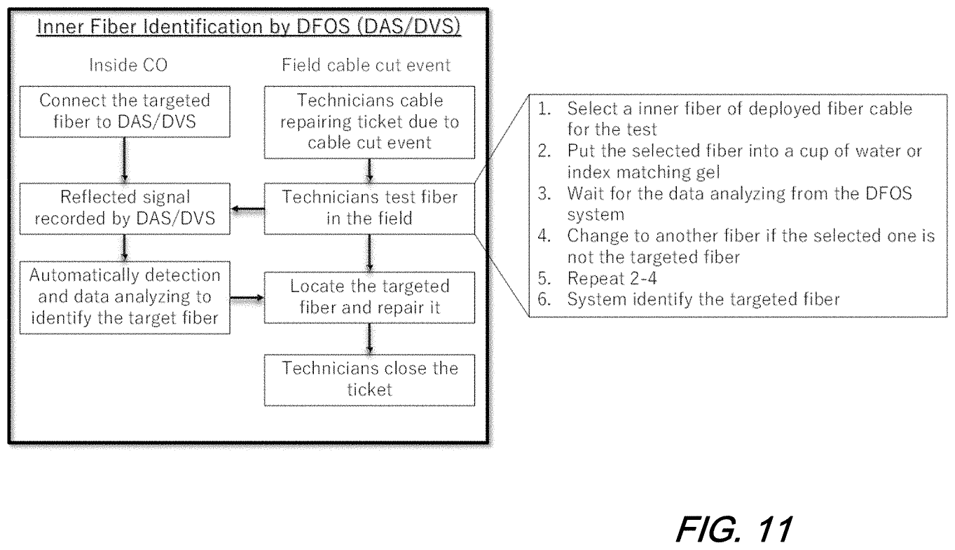

FIG. 11 is a schematic feature diagram showing illustrative features of methods according to aspects of the present disclosure. As shown illustratively in that figure, operations proceed at (inside) a central office and in-field at the location of a cable cut. Inside the central office a DFOS system DAS/DVS system is operationally connected to a targeted fiber. Reflected signals are recorded by DAS/DVS and an automatic detection and analysis is performed to identify target (affected) fiber. Cooperatively, in-field operations include technician deployment and in-field operational testing in cooperation with the operating DAS/DVS. The process of testing individual fibers until the targeted one is determined is repeatedly performed. Once the fiber(s) are identified, they are repaired and traffic operation may resume.

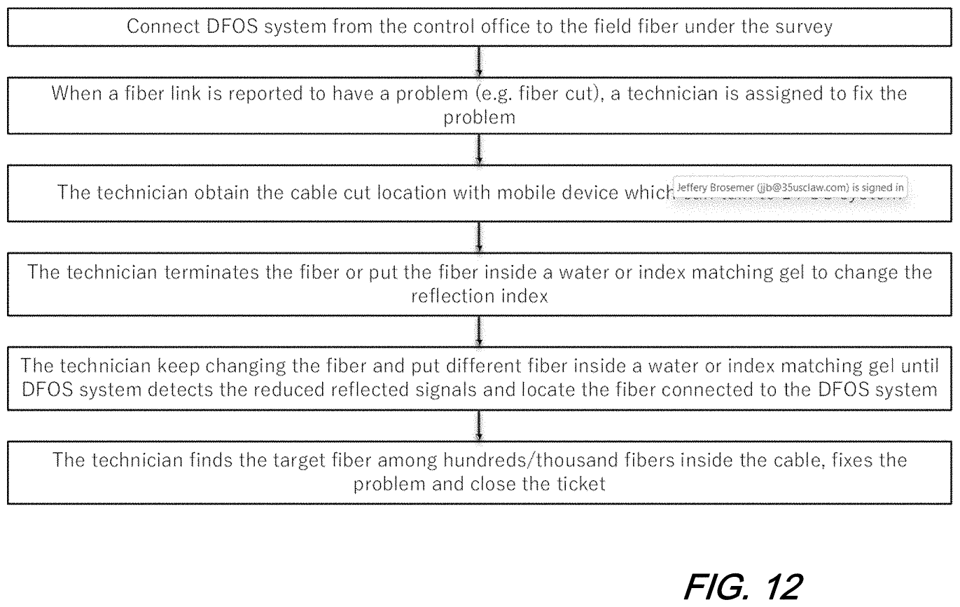

FIG. 12 is a flow diagram showing an illustrative method according to aspects of the present disclosure.

At this point, while we have presented this disclosure using some specific examples, those skilled in the art will recognize that our teachings are not so limited. Accordingly, this disclosure should be only limited by the scope of the claims attached hereto.

1. A method for identifying inner fibers of a cut fiber cable using a distributed fiber optic sensing system (DFOS), the method comprising:
providing a distributed fiber optic sensing system (DFOS), said system including
a length of cut optical fiber cable having a plurality of individual, cut optical fibers contained therein; and
a DFOS interrogator and analyzer, said DFOS interrogator configured to generate optical pulses from laser light, introduce the pulses into an optical fiber and detect/receive Rayleigh reflected signals from the optical fiber, said analyzer configured to analyze the Rayleigh reflected signals and generate location/time waterfall plots from the analyzed Rayleigh reflected signals;
connecting the DFOS system to an individual one of the optical fibers contained in the length of cut optical fiber cable;
placing a cut end of one of the individual cut, optical fibers into an index matching gel;
operating the DFOS system and determining if the individual optical fiber that the DFOS system is connected to is the same fiber placed in the index matching gel from received reflected signals;
providing an indication of the determination; and
repeating the above-procedure for successive cut individual fibers.

2. The method of claim 1 further comprising providing real time feedback from a location of the fiber cut using a mobile device.
